(19) United States
(12) Patent Application Publication
(10) Pub. No.: US 2026/0146942 A1
(43) Pub. Date: May 28, 2026

(54) HYDROGEN CONCENTRATION MEASUREMENT METHOD

(71) Applicant: ELECTRONICS AND TELECOMMUNICATIONS RESEARCH INSTITUTE, Daejeon (KR)

(72) Inventors: Soocheol Kim, Daejeon (KR); Yusun Ahn, Daejeon (KR); Kang Bok Lee, Daejeon (KR); Hye Sun Lee, Daejeon (KR); Kyu Won Han, Daejeon (KR)

(21) Appl. No.: 19/331,329

(22) Filed: Sep. 17, 2025

(30) Foreign Application Priority Data
Nov. 28, 2024 (KR) 10-2024-0173204

(51) Int. Cl. G01N 21/3504; G01N 21/17; G01N 21/3581; G01N 21/359; G01N 21/47; G01N 21/51; G01N 21/75

(52) U.S. Cl. CPC G01N 21/3504; G01N 21/3581; G01N 21/359; G01N 21/4788; G01N 21/51; G01N 21/75; G01N 2021/1765; G01N 2021/479; G01N 2021/755

(57) ABSTRACT

Provided is a hydrogen concentration measurement method including sequentially aligning a light source, a hydrogen detector including nanoparticles, and an image sensor, allowing the nanoparticles to react with hydrogen to provide hydrogenated nanoparticles, and substantially simultaneously passing light, emitted from the light source, through the hydrogen detector to allow the light to enter the image sensor, acquiring a speckle image from the light entering the image sensor, and detecting a hydrogen concentration from the speckle image.

### CROSS-REFERENCE TO RELATED APPLICATION

This U.S. non-provisional patent application claims priority under 35 U.S.C. § 119 of Korean Patent Application No. 10-2024-0173204, filed on Nov. 28, 2024, the entire contents of which are hereby incorporated by reference.

### BACKGROUND

The present disclosure herein relates to a hydrogen concentration measurement method, and more particularly, to a hydrogen concentration measurement method using a speckle image.

A hydrogen concentration measurement method is a technology required in various fields such as a hydrogen fuel cell, a chemical process, environmental monitoring, health care, and the like. As a representative hydrogen concentration measurement method, there are an electrochemical method, a thermal conductivity measurement method, an optical method, a colorimetric sensor, a metal-hydrogen reaction sensor, and the like.

The electrochemical method uses an electrochemical cell to measure a current generated or consumed by an oxidation or reduction reaction of hydrogen and may be used in real-time measurement. However, it is disadvantageous in that a sensor used for the method is sensitive to external factors. The thermal conductivity measurement method is performed by detecting a hydrogen concentration in a mixed gas using a high thermal conductivity of hydrogen. The method is simple and highly reliable, but it is disadvantageous in that the accuracy may be expected only under a specific temperature condition.

The optical method is a highly precise technology for utilizing spectroscopy to analyze the spectrum of hydrogen molecules. However, equipment used in the method is complicated and expensive. The colorimetric sensor is based on a principle in which when a specific compound reacts with hydrogen, the color of the compound changes, but has a disadvantage of low precision.

On the other hand, the metal-hydrogen reaction sensor measures a hydrogen concentration using the characteristics of a palladium metal that easily reacts with a hydrogen gas. Therefore, the metal-hydrogen reaction sensor has advantages of a low explosion risk, easy miniaturization, and an inexpensive manufacturing cost. Accordingly, various studies have been conducted on the metal-hydrogen reaction sensor.

### SUMMARY

The present disclosure provides a hydrogen concentration measurement method with improved stability.

The present disclosure also provides a miniaturized hydrogen concentration measurement device and a hydrogen measurement method using the same.

Issues to be addressed in the present disclosure are not limited to those described above and other issues unmentioned above will be clearly understood by those skilled in the art from the following description.

An embodiment of the inventive concept provides a hydrogen concentration measurement method including: sequentially aligning a light source, a hydrogen detector including nanoparticles, and an image sensor; allowing the nanoparticles to react with hydrogen to provide hydrogenated nanoparticles, and substantially simultaneously passing light, emitted from the light source, through the hydrogen detector to allow the light to enter the image sensor; acquiring a speckle image from the light entering the image sensor; and detecting a hydrogen concentration from the speckle image.

In an embodiment of the inventive concept, a hydrogen concentration measurement method includes: sequentially aligning a light source, a hydrogen detector including nanoparticles, and an image sensor; passing light, emitted from the light source, through the hydrogen detector to allow the light to enter the image sensor; allowing the nanoparticles to react with hydrogen to provide hydrogenated nanoparticles, and substantially simultaneously providing a speckle image from the light passing through the hydrogen detector; and detecting a hydrogen concentration from the speckle image.

In an embodiment of the inventive concept, a hydrogen concentration measurement method includes: sequentially aligning a light source, a hydrogen detector including nanoparticles, and an image sensor; passing light, emitted from the light source, through the hydrogen detector to allow the light to enter the image sensor; allowing the nanoparticles to react with hydrogen to provide hydrogenated nanoparticles, and substantially simultaneously providing a speckle image from the light passing through the hydrogen detector; acquiring, from the speckle image, a diameter change ratio of the nanoparticles in the hydrogen detector; and detecting a hydrogen concentration from the diameter change ratio.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept.

In the drawings:

FIG. 1 is a flow chart for explaining a hydrogen concentration measurement method according to an embodiment of the inventive concept;

FIG. 2 is a drawing for explaining hydrogen concentration measurement devices according to an embodiment of the inventive concept;

FIGS. 3 and 4 are cross-sectional views corresponding to line A-A′ of FIG. 2 as drawings showing a hydrogen detector according to an embodiment of the inventive concept;

FIG. 5 is a flow chart for explaining a method for detecting a hydrogen concentration from a speckle image according to an embodiment of the inventive concept;

FIG. 6 is experimental data for explaining a relationship between a correlation coefficient and a hydrogen concentration according to an embodiment of the inventive concept;

FIG. 7 is a flow chart for explaining a method for detecting a hydrogen concentration from a speckle image according to another embodiment of the inventive concept;

FIG. 8 is experimental data for explaining a relationship between a light intensity value and a hydrogen concentration according to an embodiment of the inventive concept;

FIGS. 9 and 10 are photos for explaining a speckle image according to embodiments of the inventive concept;

FIG. 11 is a flow chart for explaining a hydrogen concentration measurement method according to another embodiment of the inventive concept;

FIG. 12 is a flow chart for explaining a hydrogen concentration measurement method according to another embodiment of the inventive concept;

FIG. 13 is experimental data for explaining a relationship between a correlation coefficient and a diameter change ratio according to an embodiment of the inventive concept; and

FIG. 14 is experimental data for explaining a relationship between a light intensity value and a diameter change ratio according to an embodiment of the inventive concept.

### DETAILED DESCRIPTION

The embodiments of the present invention will now be described with reference to the accompanying drawings for sufficiently understating a configuration and effects of the inventive concept. However, the inventive concept is not limited to the following embodiments and may be embodied in different ways, and various modifications may be made thereto. The embodiments are just given to provide complete disclosure of the inventive concept and to provide thorough understanding of the inventive concept to those skilled in the art. In the accompanying drawings, the sizes of the elements may be greater than the actual sizes thereof, for convenience of description, and the scales of the elements may be exaggerated or reduced.

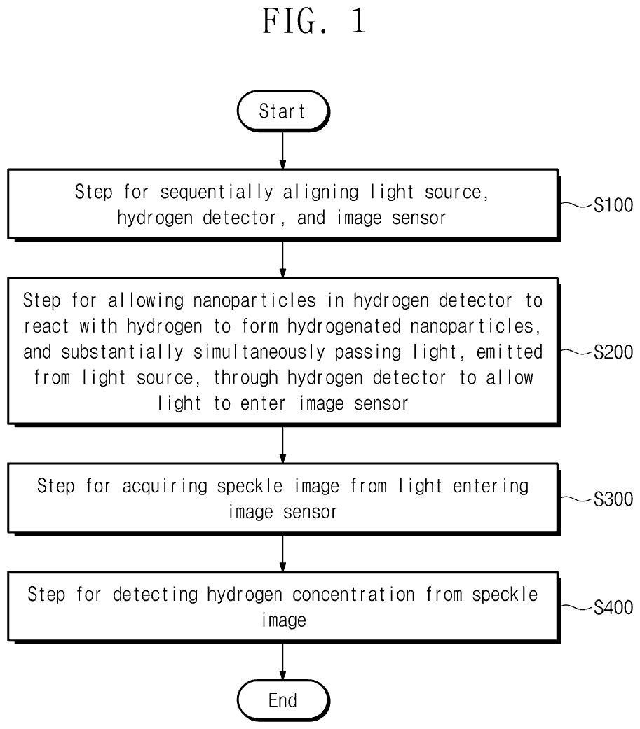

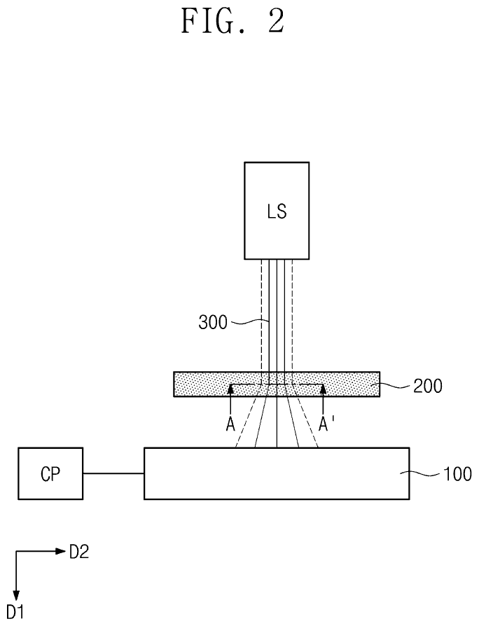

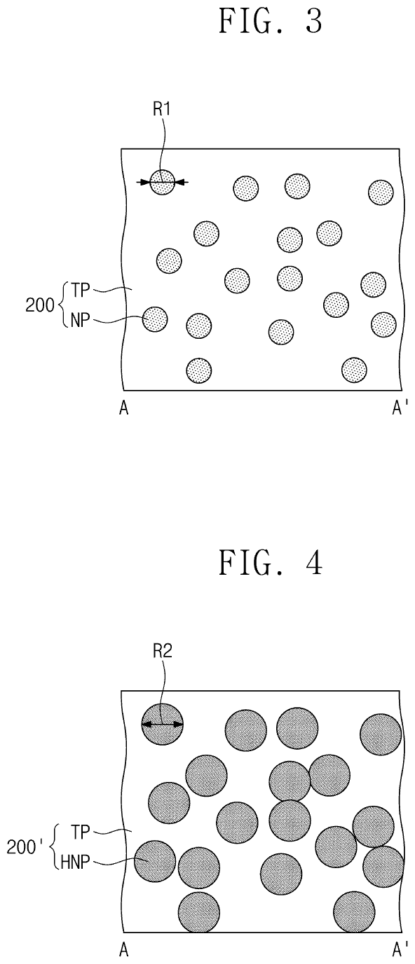

FIG. 1 is a flow chart for explaining a hydrogen concentration measurement method according to an embodiment of the inventive concept. FIG. 2 is a drawing for explaining hydrogen concentration measurement devices according to an embodiment of the inventive concept. FIGS. 3 and 4 are cross-sectional views corresponding to line A-A′ of FIG. 2 as drawings showing a hydrogen detector according to an embodiment of the inventive concept. More specifically, FIG. 3 is a cross-sectional view before the hydrogen detector reacts with hydrogen, and FIG. 4 is a cross-sectional view after the hydrogen detector reacts with the hydrogen.

Referring to FIGS. 1 to 4, a light source LS, a hydrogen detector 200, and an image sensor 100 may be sequentially aligned (S100).

The light source LS may include a light-emitting element configured to emit light 300. By way of an example, the light source LS may include a laser diode or a light-emitting diode (LED).

The light source LS may emit the light 300 in a first direction D1 towards the hydrogen detector 200. The light 300 emitted from the light source LS may pass through the hydrogen detector 200, and be refracted while passing through the hydrogen detector 200. The light 300 may pass through a transparent material TP to be described below in the hydrogen detector 200, and be refracted while passing through the transparent material TP. The light 300 passing through the hydrogen detector 200 may enter the image sensor 100 (S200). The entering of the light 300 passing through the hydrogen detector 200 to the image sensor 100 may proceed substantially simultaneously with allowing a plurality of nanoparticles (NP of FIG. 3) in the hydrogen detector 200 to react with hydrogen to form hydrogenated nanoparticles (HNP of FIG. 4) (S200).

A wavelength of the light 300 may be about 280 nm to about 1 mm. By way of an example, the light 300 may be at least one of visible rays, near-infrared rays, infrared rays, or far-infrared rays.

The hydrogen detector 200 may include the plurality of nanoparticles NP and the transparent material TP. By way of an example, the hydrogen detector 200 may have the structure in which the nanoparticles NP and the transparent material TP are disposed on a transparent substrate, but an embodiment is not limited thereto. By way of another example, although not shown in the drawing, the hydrogen detector 200 may have the shape of a transparent porous case in which the nanoparticles NP and the transparent material TP are housed. The hydrogen detector 200 may have the structure extending in a second direction D2 vertical to the first direction D1, but an embodiment is not limited thereto. The hydrogen detector 200 may have a thickness of about 10 nm to about 10 mm in the first direction D1. The nanoparticles NP and the transparent material TP will be described below.

The image sensor 100 may receive the light 300 passing through the hydrogen detector 200 (S200). The image sensor 100 may generate an image from the entering light 300. The image sensor 100 may transmit the generated image to a computing device CP. By way of an example, the image sensor 100 may be a complementary metal oxide semiconductor (CMOS) image sensor or a charge-coupled device (CCD) image sensor.

The computing device CP may acquire a speckle image changing in real time by continuously receiving images generated from the image sensor 100 (S300). The speckle image may be defined as a set of a series of images generated by interference of light. The images generated by the image sensor 100 may have a certain pattern, but the generated images may have different patterns according to the size of the nanoparticle (NP of FIG. 3) to be described below. Through the speckle image, a pattern change according to the size of the nanoparticle (NP of FIG. 3) may be confirmed.

The computing device CP may analyze the speckle image to detect a hydrogen concentration (S400). The computing device CP may acquire a correlation coefficient from the speckle image to detect the hydrogen concentration, or acquire a light intensity value to detect the hydrogen concentration. Each hydrogen concentration detection method will be described below.

A hydrogen concentration measurement method according to the inventive concept may use only components of the light LS, the hydrogen detector 20, and the image sensor 100 to measure the hydrogen concentration. Thereby, the small light source LS, the small hydrogen detector 200, and the small image sensor 100 may be used as necessary to easily miniaturize the hydrogen concentration measurement device according to the inventive concept.

Referring to FIGS. 2 and 3, the hydrogen detector 200 may include the nanoparticles NP and the transparent material TP surrounding the nanoparticles NP.

The nanoparticles NP may include a material that reacts with hydrogen to detect the hydrogen, and include a material with high reactivity to the hydrogen. The nanoparticles NP may react with the hydrogen to allow the hydrogen detector 200 to serve to detect the hydrogen. By way of an example, the nanoparticle NP may include palladium (Pd).

The nanoparticle NP may have a spherical shape, but is not limited thereto, and may have various shapes unlike the shown in the drawings.

The nanoparticle NP may have a first diameter R1. The first diameter R1 may be defined as an average value of the diameters of the nanoparticles NP.

The transparent material TP may be provided to surround the nanoparticle NP. The transparent material TP may include a material with a high transmissivity of the light 300. By way of an example, in the hydrogen detector 200 having the shape of a transparent porous case, the transparent material TP may fill the inside of the transparent porous case except for the nanoparticles NP. By way of another example, unlike the previous embodiment, when the hydrogen detector 200 has the structure in which the nanoparticles NP and the transparent material TP are disposed on a transparent substrate, the transparent material TP may include air, which means a portion being substantially empty. However, this is an example, and the embodiment of the inventive concept is not limited thereto.

Referring to FIGS. 3 and 4, the hydrogen detector 200 may be a reacting hydrogen detector 200′ that has reacted with hydrogen. The reacting hydrogen detector 200′ may include the hydrogenated nanoparticle HNP and the transparent material TP surrounding the hydrogenated nanoparticle HNP.

The hydrogenated nanoparticle HNP may be formed by the reaction of the nanoparticle with hydrogen (S200). By way of an example, the hydrogenated nanoparticle HNP may be hydrogenated palladium PdHx formed by the reaction of palladium Pd with the hydrogen.

The hydrogenated nanoparticle HNP may have a spherical shape, but is not limited thereto, and may have various shapes unlike the shown in the drawing. The hydrogenated nanoparticle HNP may have a second diameter R2.

The second diameter R2 may be defined as an average value of the diameters of the nanoparticles HNP.

The second diameter R2 may be larger than the first diameter R1. In other words, the hydrogenated nanoparticle HNP may react with hydrogen and have a larger size than the nanoparticle NP.

Referring to FIGS. 2, 3 and 4, a pattern of the speckle image may change according to the size of the hydrogenated nanoparticle HNP in the reacting hydrogen detector 200′. The computing device CP may analyze a pattern change of the speckle image to detect a hydrogen concentration.

A hydrogen concentration measurement method according to the inventive concept may have a less explosion risk than an electrochemical method or a thermal conductivity measurement method by irradiating, with the light 300, the nanoparticle NP of which the size changes according to the hydrogen concentration, using the light 300 entering the image sensor 100 to form a speckle image, and detecting the hydrogen concentration through the speckle image. Accordingly, the hydrogen concentration measurement method according to the inventive concept may have improved stability in comparison to the existing electrochemical method or thermal conductivity measurement method.

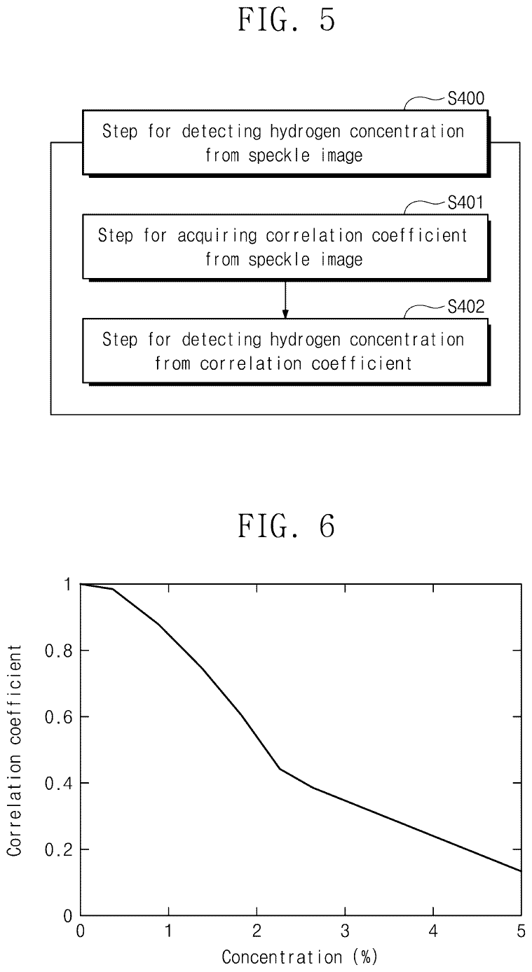

FIG. 5 is a flow chart for explaining a method for detecting a hydrogen concentration from a speckle image according to an embodiment of the inventive concept.

Referring to FIGS. 2 and 5, the step for detecting the hydrogen concentration from the speckle image (S400) may include a step for acquiring a correlation coefficient from the speckle image (S401), and a step for detecting the hydrogen concentration from the correlation coefficient (S402).

The step for acquiring a correlation coefficient from the speckle image (S401) may be performed by the computing device CP. The computing device CP may derive the correlation coefficient through the pattern change in the speckle image.

The correlation coefficient may be defined as a parameter for measuring the similarity between a reference image and comparative images, and the correlation coefficient may have a value of about 0 to about 1. The reference image may be defined as an image generated by the image sensor 100 from the light 300 passing through the hydrogen detector 200 before reacting with hydrogen. The comparative images may be defined as images generated by the image sensor 100 from the light 300 passing through the reacting hydrogen detector 200′ after reacting with the hydrogen. The speckle image may mean an image in which the reference image and the comparative images are successively connected.

The correlation coefficient is defined by Equation (1). Equation (1) is expressed as

$$R ( τ ) = {{\int }_{- ∞}^{∞}}_{} f ( t ) g ( t + τ ) dt ,$$

where R(τ) denotes the correlation coefficient, τ denotes a shift variable, f(t) denotes the reference image, and g(t) denotes the comparative images.

The computing device CP may receive the reference image and the comparative images from the image sensor 100, and derive the correlation coefficient through Equation (1). In other words, the computing device CP may acquire the correlation coefficient from the speckle image (S401).

The step for detecting the hydrogen concentration from the correlation coefficient (S402) may be performed by the computing device CP. The correlation coefficient may have a certain relationship with the hydrogen concentration. Accordingly, the hydrogen concentration may be detected with the correlation coefficient using the relationship between the correlation coefficient and the hydrogen concentration. By way of an example, the correlation coefficient may satisfy Equation (2), but an embodiment is not limited thereto. The computing device CP may detect the hydrogen concentration using Equation (2).

Equation (2) is expressed as y=−16.02x³+30.45x²−21.87x+7.438, where y denotes the hydrogen concentration (%), and x denotes the correlation coefficient.

FIG. 6 is experimental data for explaining the relationship between the correlation coefficient and the hydrogen concentration according to an embodiment of the inventive concept.

Referring to FIG. 6, it may be confirmed that as the correlation coefficient decreases, the hydrogen concentration increases.

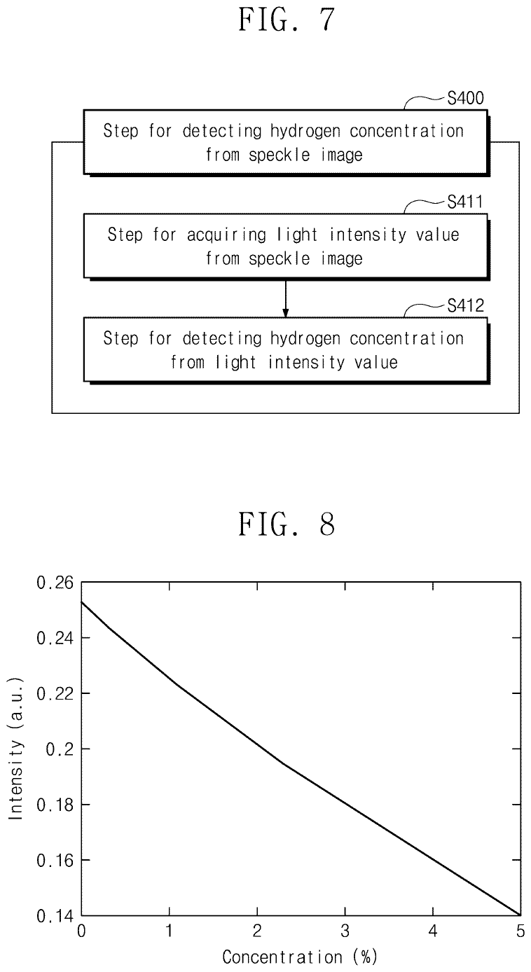

FIG. 7 is a flow chart for explaining a method for detecting the hydrogen concentration from the speckle image according to another embodiment of the inventive concept.

Referring to FIGS. 2 and 7, the step for detecting the hydrogen concentration from the speckle image (S400) may include a step for acquiring a light intensity value from the speckle image (S411), and a step for detecting the hydrogen concentration from the light intensity value (S412).

The step for acquiring the light intensity value from the speckle image (S411) may be performed by the computing device CP. The computing device CP may analyze the speckle image to detect a light intensity, and through this, may acquire the light intensity value. By way of another example, the detecting of the light intensity may be performed by the image sensor 100, the image sensor 100 may transmit data about the light intensity to the computing device CP, and the computing device CP may acquire the light intensity value.

The light intensity value may be defined as a relative ratio of the intensity of light passing through the reacting hydrogen detector 200′ (of FIG. 4) based on the intensity of light passing through the hydrogen detector 200. By way of an example, when the intensity of the light passing through the hydrogen detector 200 before reacting with the hydrogen is set to 0.2492 a.u., the light intensity value may be considered as a value obtained by calculating the relative ratio of the intensity of the light passing through the reacting hydrogen detector 200′ to 0.2492 a.u.

The light intensity value may have a certain relationship with the hydrogen concentration. Accordingly, the hydrogen concentration may be detected with the light intensity value using the relationship between the light intensity value and the hydrogen concentration. By way of an example, the light intensity value and the hydrogen concentration may satisfy Equation (3), but are not limited thereto. Equation (3) is expressed as y=−44.58x+11.11. Here, y denotes the hydrogen concentration (%) and x denotes the light intensity value (a.u.).

The computing device CP may acquire the light intensity value through the speckle image, and detect the hydrogen concentration through Equation (3). In other words, the computing device CP may detect the hydrogen concentration from the light intensity value (S402).

FIG. 8 is experimental data for explaining a relationship between the light intensity value and the hydrogen concentration according to an embodiment of the inventive concept.

Referring to FIG. 8, it may be confirmed that as the light intensity value decreases, the hydrogen concentration increases.

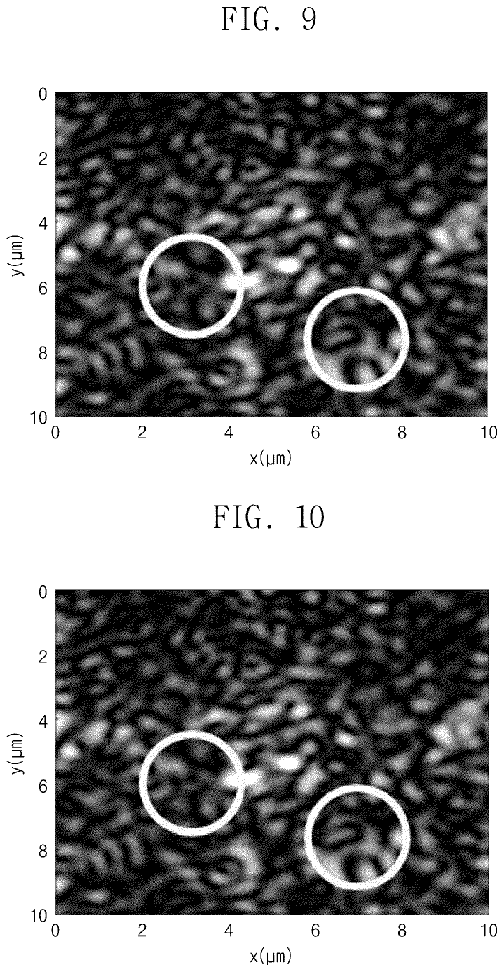

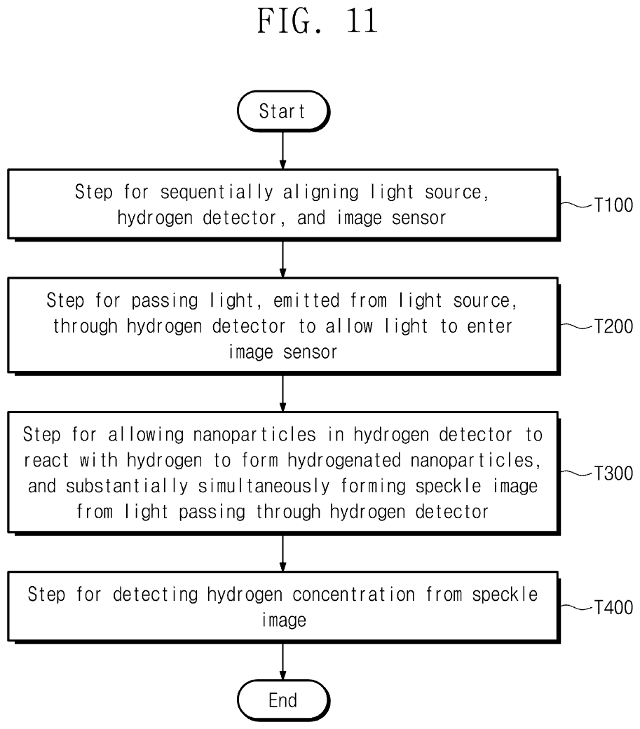

FIGS. 9 and 10 are photos for explaining the speckle images according to embodiments of the inventive concept. More specifically, FIG. 9 is the photo showing the reference image before the hydrogen detector reacts with the hydrogen, and FIG. 10 is the photo showing the comparative image after the hydrogen detector reacts with the hydrogen.

Referring to FIGS. 2, 9, and 10, the computing device CP may identify the reference image (FIG. 9) and the comparative image (FIG. 10) received through the image sensor 100. Each of the reference image (FIG. 9) and the comparative image (FIG. 10) may form a series of patterns. The pattern of the reference image (FIG. 9) may have a wider interval than the pattern of the comparative image (FIG. 10). However, unlike the shown in the drawing, the pattern of the comparative image may have a wider interval than the pattern of the reference image according to the wavelength of the light, the distance between the light source LS and the hydrogen detector 200, and the distance between the hydrogen detector 200 and the image sensor 100.

Thereby, it may be confirmed that the computing device CP may acquire speckle images showing a process in which the pattern of the reference image (FIG. 9) changes to the pattern of the comparative image (FIG. 10), and acquire the correlation coefficient and the light intensity value from the acquired speckle images.

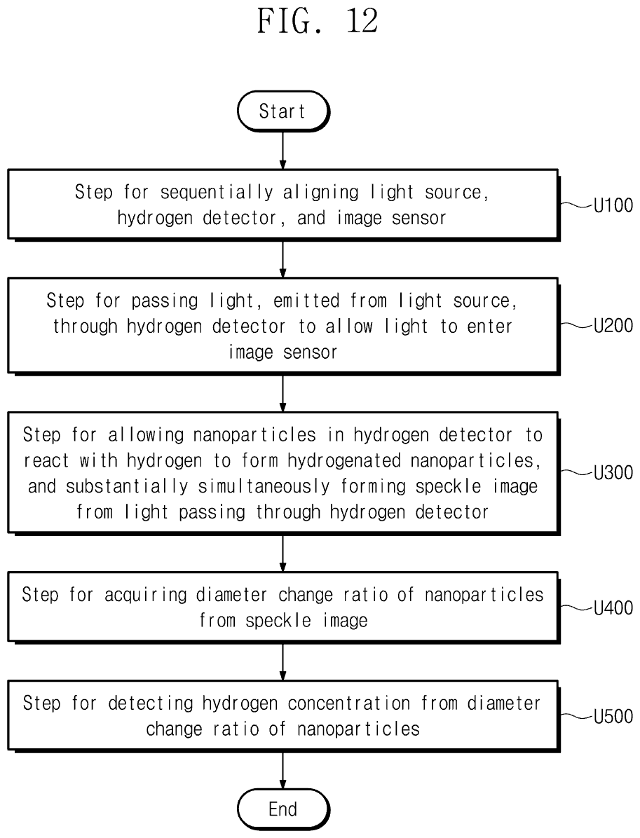

FIG. 11 is a flow chart for explaining a hydrogen concentration measurement method according to another embodiment of the inventive concept. However, differences from the hydrogen concentration measurement according to the foregoing embodiment of the inventive concept will be mainly explained. For concise explanation, detailed description of the same/similar components to the foregoing components will be omitted.

Referring to FIGS. 2, 3, 4, and 11, the light source LS, the hydrogen detector 20, and the image sensor 100 may be sequentially aligned (T100), and the light 300 emitted from the light source LS may pass through the hydrogen detector 200 to enter the image sensor 100.

The image sensor 100 may generate an image from the entering light 300, the computing device CP may receive the image transmitted from the image sensor 100 to form a speckle image, and the nanoparticles NP in the hydrogen detector 200 may react with the hydrogen to form the hydrated nanoparticles HNP (T300). Allowing the nanoparticles NP in the hydrogen detector 200 to react with the hydrogen to form the hydrated nanoparticles HNP may substantially simultaneously proceed with formation of the speckle image from the light 300 (T300).

After forming the speckle image, the hydrogen concentration may be detected from the speckle image (T400). As described above, detecting the hydrogen concentration may be performed by the computing device CP, and the detection may be performed using the correlation coefficient or the light intensity value.

FIG. 12 is a flow chart for explaining a hydrogen concentration measurement method according to another embodiment of the inventive concept. However, differences from hydrogen concentration measurement according to the foregoing embodiment of the inventive concept will be mainly explained. For concise explanation, detailed description of the same/similar components to the foregoing components will be omitted.

Referring to FIGS. 2, 3, 4, and 12, the light source LS, the hydrogen detector 20, and the image sensor 100 may be sequentially aligned (U100), and the light 300 emitted from the light source LS may pass through the hydrogen detector 200 to enter the image sensor 100.

The image sensor 100 may generate an image from the entering light 300, the computing device CP may receive the image transmitted from the image sensor 100 to form the speckle image, and the nanoparticles NP in the hydrogen detector 200 may react with the hydrogen to form the hydrated nanoparticles HNP (U300). Allowing the nanoparticles NP in the hydrogen detector 200 to react with the hydrogen to form the hydrated nanoparticles HNP may substantially simultaneously proceed with formation of the speckle image from the light 300 (U300).

After forming the speckle image, a diameter change ratio of the nanoparticles may be acquired from the speckle image (U400). The diameter change ratio of the nanoparticles NP may be defined as a ratio of the second diameter R2 of the hydrogenated nanoparticle HNP to the first diameter R1 of the nanoparticle NP. The second diameter R1 may be larger than the first diameter R1, and accordingly the diameter change ratio may be a value of about 1 or greater. By way of an example, the diameter change ratio may be about 1 to about 1.2, but is not limited thereto.

Acquiring the diameter change ratio of the nanoparticles NP from the speckle image may be performed by the computing device CP. The computing device CP may analyze a pattern change in the speckle image to calculate the diameter change ratio, but an embodiment is not limited thereto.

The hydrogen concentration may be detected from the diameter change ratio of the nanoparticles NP (U500). By way of an example, the correlation coefficient corresponding to the diameter change ratio may be calculated from the diameter change ratio, and the hydrogen concentration may be detected from the correlation coefficient using the relationship between the correlation coefficient and the hydrogen concentration (e.g., Equation (2)). By way of another example, the light intensity value corresponding to the diameter change ratio may be calculated from the diameter change ratio, and the hydrogen concentration may be detected from the light intensity value using the relationship between the light intensity value and the hydrogen concentration (e.g., Equation (3)).

FIG. 13 is experimental data for explaining the relationship between the correlation coefficient and the diameter change ratio according to an embodiment of the inventive concept.

Referring to FIG. 13, it may be confirmed that as the diameter change ratio increases, the correlation coefficient becomes smaller and the detected hydrogen concentration increases.

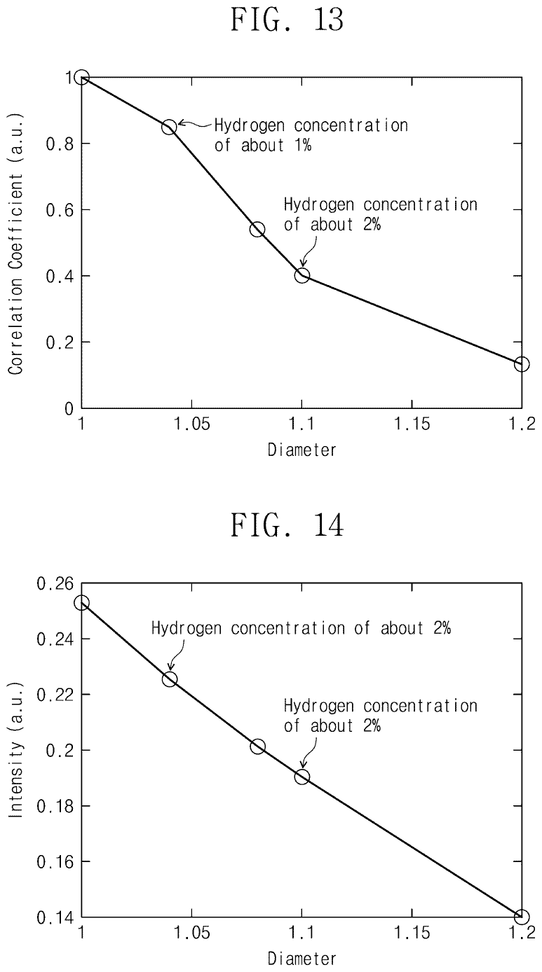

FIG. 14 is experimental data for explaining a relationship between the light intensity value and the diameter change ratio according to an embodiment of the inventive concept.

Referring to FIG. 14, it may be confirmed that as the diameter change ratio increases, the light intensity value becomes smaller and the detected hydrogen concentration increases.

The hydrogen concentration measurement method according to the inventive concept has a lower explosion risk than an electrochemical method or a thermal conductivity measurement method because the hydrogen concentration measurement method uses size change characteristics of nanoparticles that react with hydrogen and measures information about the size change characteristics using light. Accordingly, the hydrogen concentration measurement method according to the inventive concept may have improved stability in comparison to the existing electrochemical method or thermal conductivity measurement method.

According to the inventive concept, a hydrogen concentration may be measured using a laser light source, a hydrogen detector, and an image sensor. Thereby, in the hydrogen concentration measurement device according to the inventive concept, each component may be easily miniaturized in comparison to a hydrogen measurement device using an electrochemical method or an optical method. Thereby, a comparatively miniaturized device may be provided, and a hydrogen concentration measurement method using the same may be provided.

It should be noted that effects of the present disclosure are not limited to those described above and other effects of the present disclosure will be apparent to those skilled in the art from the following descriptions.

Although the exemplary embodiments of the present invention have been described, it is understood that the present invention may be implemented as other concrete forms without changing the inventive concept or essential features. It is therefore to be understood that the above-described embodiments are illustrative in all aspects and not restrictive.

What is claimed is:

1. A hydrogen concentration measurement method comprising:
sequentially aligning a light source, a hydrogen detector comprising nanoparticles, and an image sensor;
allowing the nanoparticles to react with hydrogen to provide hydrogenated nanoparticles, and substantially simultaneously passing light, emitted from the light source, through the hydrogen detector to allow the light to enter the image sensor;
acquiring a speckle image from the light entering the image sensor; and
detecting a hydrogen concentration from the speckle image.

2. The hydrogen concentration measurement method of claim 1,
wherein the detecting of the hydrogen concentration from the speckle image comprises:
acquiring a correlation coefficient from the speckle image; and
detecting the hydrogen concentration from the correlation coefficient.

3. The hydrogen concentration measurement method of claim 2,
wherein the correlation coefficient is acquired using following Equation (1),
$$R ( τ ) = {\int }_{- ∞}^{∞} f ( t ) g ( t + τ ) dt \qquad ( 1 )$$
wherein R(τ) denotes the correlation coefficient, t denotes a shift variable, f(t) denotes a reference image, and g(t) denotes comparative images.

4. The hydrogen concentration measurement method of claim 2,
wherein the hydrogen concentration is detected using following Equation (2),
$$y = - 16.02 {x}^{3} + 30.45 {x}^{2} - 21.87 x + 7.438 \qquad ( 2 )$$
where y denotes the hydrogen concentration (%), and x denotes the correlation coefficient.

5. The hydrogen concentration measurement method of claim 1,
wherein the detecting of the hydrogen concentration from the speckle image comprises:
acquiring a light intensity value from the speckle image; and
detecting the hydrogen concentration from the light intensity value.

6. The hydrogen concentration measurement method of claim 5,
wherein the hydrogen concentration is detected using following Equation (3),
$$y = - 44.58 x + 11.11 \qquad ( 3 )$$
where, y denotes the hydrogen concentration (%) and x denotes the light intensity value (a.u.).

7. The hydrogen concentration measurement method of claim 1,
wherein a diameter of each of the hydrogenated nanoparticles is larger than a diameter of each of the nanoparticles.

8. The hydrogen concentration measurement method of claim 1,
wherein each of the nanoparticles comprises a palladium nanoparticle.

9. The hydrogen concentration measurement method of claim 1,
wherein a wavelength of the light is about 380 nm to about 1 mm.

10. The hydrogen concentration measurement method of claim 1,
wherein the hydrogen detector has a thickness of about 10 nm to about 10 mm in a direction parallel to a direction to which the light is emitted.

11. A hydrogen concentration measurement method comprising:
sequentially aligning a light source, a hydrogen detector comprising nanoparticles, and an image sensor;
passing light, emitted from the light source, through the hydrogen detector to allow the light to enter the image sensor;
allowing the nanoparticles to react with hydrogen to provide hydrogenated nanoparticles, and substantially simultaneously providing a speckle image from the light passing through the hydrogen detector; and
detecting a hydrogen concentration from the speckle image.

12. The hydrogen concentration measurement method of claim 11,
wherein the detecting of the hydrogen concentration from the speckle image comprises:
acquiring a correlation coefficient from the speckle image; and
detecting the hydrogen concentration from the correlation coefficient.

13. The hydrogen concentration measurement method of claim 11,
wherein the detecting of the hydrogen concentration from the speckle image comprises:
detecting a light intensity value from the speckle image; and
detecting the hydrogen concentration from the light intensity value.

14. The hydrogen concentration measurement method of claim 11,
wherein the light comprises at least one of visible rays or infrared rays.

15. A hydrogen concentration measurement method comprising:
sequentially aligning a light source, a hydrogen detector comprising nanoparticles, and an image sensor;
passing light, emitted from the light source, through the hydrogen detector to allow the light to enter the image sensor;
allowing the nanoparticles to react with hydrogen to provide hydrogenated nanoparticles, and substantially simultaneously providing a speckle image from the light passing through the hydrogen detector;
acquiring, from the speckle image, a diameter change ratio of the nanoparticles in the hydrogen detector; and
detecting a hydrogen concentration from the diameter change ratio.

16. The hydrogen concentration measurement method of claim 15,
wherein the diameter change ratio is about 1 to about 1.2.
